(19) United States
(12) Patent Application Publication
(10) Pub. No.: US 2014/0266982 A1
(43) Pub. Date: Sep. 18, 2014

(54) SYSTEM AND METHOD FOR CONTROLLING AN EVENT IN A VIRTUAL REALITY ENVIRONMENT BASED ON THE BODY STATE OF A USER

(71) Applicant: Bertrand NEPVEU, Montreal (CA)

(72) Inventor: Bertrand NEPVEU, Montreal (CA)

(21) Appl. No.: 13/797,054

(22) Filed: Mar. 12, 2013

(51) Int. Cl. G02B 27/01

(52) U.S. Cl. CPC G02B 27/017
USPC 345/8

(57) ABSTRACT

A system for controlling an event in a virtual reality environment is provided. The virtual reality environment is provided by a host controlled by an input device having a plurality of control inputs for allowing a user to control the event. The system comprises an input/output interface and a processor. The input/output interface provides for communicating with at least one sensor and the host. The at least one sensor provides for the detection of a real-time body state of the user. The processor is in communication with the input/output interface. The processor is so configured so as to associate the detected real-time body state with at least one of the plurality of control inputs and to provide an input representative of the associated control inputs to the host. The real-time body state of the user controls the event. A head mounted device comprises the input/output interface and the processor. Associated devices, kits and methods are also provided.

### TECHNICAL FIELD

The present disclosure generally, relates to systems, devices, kits and methods for controlling an event in a virtual reality environment. More specifically, but not exclusively the present disclosure relates to systems, devices, kits and methods for controlling an event in a virtual reality environment based on the body state of a user.

### BACKGROUND

Virtual reality applies to computer-simulated environments that can simulate physical presence in places in the real world, as well as in imaginary worlds. Most current virtual reality environments are primarily visual experiences, displayed either on a computer screen or through special stereoscopic displays, but some simulations include additional sensory information, such as sound through speakers or headphones.

### OBJECTS

An object of the present disclosure is to provide a system for controlling an event in a virtual reality environment based on the body state of a user.

An object of the present disclosure is to provide a device for controlling an event in a virtual reality environment based on the body state of a user.

An object of the present disclosure is to provide a kit for controlling an event in a virtual reality environment based on the body state of a user.

An object of the present disclosure is to provide a system for controlling an event in a virtual reality environment based on the body state of a user.

### SUMMARY

In accordance with an aspect of the disclosure, there is provided a system for controlling an event in a virtual reality environment provided by a host controlled by an input device having a plurality of control inputs for allowing a user to control the event, the system comprising: an input/output interface for communicating with at least one sensor and the host, the at least one sensor providing for the detection of a real-time body state of the user; a processor in communication with the input/output interface, the processor being so configured so as to: associate the detected real-time body state with at least one of the plurality of control inputs; and provide an input representative of the associated control inputs to the host, whereby the real-time body state of the user controls the event.

In an embodiment, the input/output interface is configured for communicating with the input device, and wherein the processor is further configured so as to provide the plurality of control inputs from the input device to the host.

In an embodiment, the system further comprises a display for displaying the virtual reality environment to the user. In an embodiment, the system further comprises a head mounted device for being worn by the user, In an embodiment, the head mounted device comprises the display. In an embodiment, the head mounted device comprises the input/output interface and the processor. In an embodiment, the head mounted device comprises the at least one sensor. In an embodiment, the system further comprises one or more additional sensors positioned in a surrounding area of the user.

In accordance with an aspect of the disclosure, there is provided a system for controlling an event in a virtual reality environment, the system comprising: a host for providing the virtual reality environment; an input device having a plurality of control inputs for allowing a user to control the event; at least one sensor providing for the detection of a real-time body state of the user; an input/output interface for communicating with the host, the input device and the at least one sensor; and a processor in communication with the input/output interface, the processor being so configured so as to: associate the detected real-time body state with at least one of the plurality of control inputs; provide an input representative of the associated control inputs to the host; and provide the plurality of control inputs from the input device to the host, whereby the real-time body state of the user controls the event.

In accordance with an aspect of the disclosure, there is provided a head mounted device for controlling an event in a virtual reality environment provided by a host controlled by an input device having a plurality of control inputs for allowing a user to control the event, the head mounted device comprising: an input/output interface for communicating with at least one sensor and the host, the at least one sensor providing for the detection of a real-time body state of the user; and a processor in communication with the input/output interface, the processor being so configured so as to: associate the detected real-time body state with at least one of the plurality of control inputs: and provide an input representative of the associated control inputs to the host, whereby the real-time body state of the user controls the event.

In accordance with an aspect of the disclosure, there is provided a kit for controlling an event in a virtual reality environment provided by a host controlled by an input device having a plurality of control inputs for allowing a user to control the event, the kit comprising: at least one sensor providing for the detection of a real-time body state of the user; an input/output interface for communicating with the at least one sensor and the host; and a processor in communication with the input/output interface, the processor being so configured so as to; associate the detected real-time body state with at least one of the plurality of control inputs; and provide an input representative of the associated control inputs to the host, whereby the real-time body state of the user controls the event.

In an embodiment, the kit further comprises a head mounted device, the head mounted device comprises the input/output interface and the processor. In an embodiment, the head mounted device further comprises a display for displaying the virtual reality environment. In an embodiment, the head mounted device comprises the at least one sensor. In an embodiment, the kit further comprises one or more additional sensors positioned in a surrounding area of the user. In an embodiment, the kit further comprises the input device.

In accordance with an aspect of the preset disclosure, there is provided a method for controlling an event in a virtual reality environment provided by a host controlled by an input device having a plurality of control inputs for allowing a user to control the event, the method comprising: detecting a real-time body state of the user; associating the detected real-time body state with at least one of the plurality of control inputs; and providing an input representative of the associated control inputs to the host, whereby the real-time body state of the user controls the event.

Other objects, advantages and features of the present disclosure will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a schematic representation of the system of the present disclosure in accordance with an non-limiting illustrative embodiment thereof; and

FIG. 2 is a flow diagram of the steps executed by the processor of the system of FIG. 1 accordance with an non-limiting illustrative embodiment of the present disclosure.

### DETAILED DESCRIPTION

Generally stated there is provided a system for controlling an event in a virtual reality environment. The virtual reality environment is provided by a host controlled by an input device having a plurality of control inputs for allowing a user to control the event. The system comprises an input/output interface and a processor. The input/output interface provides for communicating with at least one sensor and the host. The at least one sensor provides for the detection of a real-time body state of the user. The processor is in communication with the input/output interface. The processor is so configured so as to associate the detected real-time body state with at least one of the plurality of control inputs and to provide an input representative of the associated control inputs to the host. The real-time body state of the user controls the event. In an embodiment, there is provided a head mounted device comprising the input/output interface and the processor. Associated devices, kits and methods are also provided.

In accordance with a non-limiting embodiment of the present disclosure, there is provided a head mounted device that provides for immersing a player in a virtual reality game. A non-limiting example the present system is used within combination with the device disclosed in U.S. patent application Ser. No. 13/635,799 which is incorporated herein by reference in its entirety. The head mounted device of the present disclosure provides for tracking the state of the body of wearer via one or more sensors and to associate a detected body state to a control input for controlling an event in the virtual reality game.

Throughout the present disclosure, the term “body state” generally and without limitation relates to the position or movement the user's body.

With reference to the appended Figures, non-restrictive illustrative embodiments will be herein described so as to further exemplify the disclosure only and by no means limit the scope thereof.

FIG. 1 shows a system 10 in accordance with an illustrative embodiment. The system 10 comprises a processor 12, an associated memory 14 having stored therein processor executable code for performing the steps described herein and an input/output device 16 in communication with processor 12 for receiving and transmitting information. In an embodiment, the processor 12 is selected from the group consisting of: a field-programmable gate array (FPGA), a microprocessor, a microcontroller and the like.

The input/output interface 16 is in communication with at least one sensor, generally denoted 18. This communication can be wired or wireless communication. As such, the at least one sensor generally denoted 18, can relate to one or more sensors. In an embodiment, the one or more sensor 18 can be selected from the group consisting of: an accelerometer, a gyroscope, a magnetometer, a pressure sensor, a camera (such as an eye tracking camera), an electroencephalography (EEG) sensor or any combination thereof. Of course other suitable sensors can be used within the scope of the disclosure. The sensor or sensors 18 provide for detecting the real-time body state of the user and for transmitting this information to the processor 11.

The input/output interface 16 is also in communication with a host 20, which hosts a virtual reality environment (e.g. a virtual reality game, a virtual reality simulator etc.). This communication can be wired or wireless communication. In an embodiment, the host is selected from the group consisting of a computer, a console, such as a video game console and the like, a server and the like and any combination thereof.

The input/output interface 16 is in further communication with an input device 22. The input device 22 has a plurality of control inputs for allowing a user to control an event in the virtual reality environment. In an embodiment, the input device 22 is selected from the group consisting of: a mouse, a keyboard, touch pad, a joystick, a handheld control unit and the like and any combination thereof.

In operation, the sensor or sensors 18 detect a real time body state of the user. The detected real time body state of the user is transmitted to the processor 12. The memory 14 has stored therein processor executable code for performing the step of associating the detected real-time body state with at least one of the plurality of control inputs of the input device 22 and the step of providing an input representative of the associated control inputs to the host 20. In this way, the real-time body state of the user controls the event.

For example, an input device 22 can include a plurality of control inputs for controlling an even in a virtual reality environment providing the user to control a character in this environment to move forwards, backwards, rightwards, leftwards, to crouch, to jump, or to throw. The sensor or sensors 18 detects the real time body state of the user. For example, when the user puts one foot forward, this body state is detected by the sensor or sensors 18 and transmitted to the processor 12. This given body state has been associated with the input for causing the aforementioned character in the virtual reality environment to move forward. The processor 18 emulates this given input and sends it to the host 20 without the user touching the input device 22. Once the host 20 receives this emulated input, the aforementioned character in the virtual reality environment moves forwards. Similarly, putting one foot rearwards can correspond to the input causing the character in the virtual reality environment to move backwards, a leftwards body movement of the user can correspond to the input causing the character in the virtual reality environment to move leftwards, a rightwards body movement of the user can correspond to the input causing the character in the virtual reality environment to move rightwards, the user crouching can correspond to the input causing the character in the virtual reality environment to crouch, the user jumping can correspond to the input causing the character in the virtual reality environment to move jump, and the user's hand gesture emulating throwing can correspond to the input causing the character in the virtual reality environment to throw an object.

The memory 14 includes algorithms that associate a detected given body state to a given input.

In one embodiment, sensor fusion algorithms are used to detect specific body positions or movements. These algorithms provide for finding the real time body state of the user and translating the body state into a standard command (input) in a game for example.

Sensor fusion is well known in the art, in general it combines the sensory data (or data derived from sensory data) from disparate sources. The resulting information is more accurate, complete, holistic and/or dependable than than would be possible when these sources were used individually. The sensory date can be provided by heterogeneous or homogeneous sensors. Various sensor fusion methods are well known in the art, examples of such methods have been described in various publications such as and without limitation: Persa, Stelian-Florin (2006) Sensor Fusion in Head Pose Tracking for Augmented Reality, PhD Thesis Ubiquitous Communications (UBICOM), Delft University of Technology, DIOC research program, ISBN-10: 90-9020777-5, ISBN-13: 978-90-9020777-3; Eric Foxlin (1996) Intertial Head-Tracker Sensor Fusion by a Complementary Separate-Bias Kalman Filter Research Laboratory of Electronics, Massachusetts Institute of Technology, Proceedings of VRAIS '96, 0-8186-7295-1/9; Toyama, Kentaro & Horvitz, Eric ( ), Bayesian Modality Fusion: Probabilistic Integration of Multiple Vision Algorithms for Head Tracking, Microsoft Research, Redmond, Wash.; Elmenreich, W. (2002), Sensor Fusion in Time-Triggered Systems, PhD Thesis. Vienna, Austria: Vienna University of Technology; Einicke, G. A. (2012). Smoothing, Filtering and Prediction: Estimating the Past, Present and Future. Rijeka, Croatia: Intech. ISBN 978-953-307-752-9; N. Xiong; P. Svensson (2002). “Multi-sensor management for information fusion: issues and approaches”. Information Fusion. p. 3(2):163-186; Gross, Jason; Yu Gu, Matthew Rhudy, Srikanth Gururajan, and Marcello Napolitano (July 2012). “Flight Test Evaluation of Sensor Fusion Algorithms for Altitude Estimation”. IEEE Transactions on Aerospace and Electronic Systems 48 (3): 2128-2139. The foregoing documents are incorporated herein by reference in their entirety.

In another embodiment, the processor 12 is further configured so as to provide the plurality of control inputs from the input device 22 to the host 20. This allows a user to selectively use the input device 22 for controlling an even in the virtual reality environment when desirable.

In an embodiment, the system 10 further comprises a display 24 which provides for displaying the virtual reality environment to the user.

In an embodiment, the system 10 further comprises the one or more sensors 18. In an embodiment, the system 10 further comprises the input device. In an embodiment, the system 10 further comprises the host 20.

With reference to FIG. 2, there is shown a flow diagram of the steps executed by the processor 12 of the system 10. The first step 100 is to detect a body state of the user, this information is provided by the sensor or sensors 18 as previously described. The second step 200 is to associate the detected real-time body state with at least one of the plurality of control input. The third step 300 is to provide an input representative of the associated control inputs to the host 20. Therefore, the present disclosure in accordance with an embodiment thereof, provides a method comprising steps 100, 200 and 300.

In an embodiment, the systems 10 described herein are respectively provided in the form of a kit.

In an embodiment, the system 10 of FIG. 1 corresponds to a head mounted device. In an embodiment, the head mounted device includes a display such as a screen for displaying the virtual reality environment to the user.

In one embodiment, the one or more sensor 18 can be directly mounted on the head mounted device. In an embodiment, additional sensors can be included that are positioned at a location in the surrounding area of the user. In one embodiment, one or more sensors 18 can be mounted to the head mounted device and/or the body of the user and/or positioned at a location in the surrounding area of the user.

In one embodiment, the one or more sensor 18 is mounted on the body of the user.

In one embodiment, the one or more sensor 18 is positioned at a location in the surrounding area of the user.

It should be noted that the various components and features of the embodiments described above, whether illustrated or not, can be combined in a variety of ways so as to provide still other embodiments within the scope of claims. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been described hereinabove by way of embodiments thereof, it can be modified, without departing from the spirit, scope and nature of the invention as defined herein and in the appended claims.

What is claimed is:

1. A system for controlling an event in a virtual reality environment provided by a host controlled by an input device having a plurality of control inputs for allowing a user to control the event, the system comprising:
an input/output interface for communicating with at least one sensor and the host, the at least one sensor providing for the detection of a real-time body state of the user;
a processor in communication with the input/output interface, the processor being so configured so as to:
associate the detected real-time body state with at least one of the plurality of control inputs; and
provide an input representative of the associated control inputs to the host,
whereby the real-time body state of the user controls the event.

2. The system of claim 1, wherein the input/output interface is configured for communicating with the input device, and wherein the processor is further configured so as to provide the plurality of control inputs from the input device to the host.

3. The system of claim 1, further comprising a display for displaying the virtual reality environment to the user.

4. The system of claim 3, further comprising a head mounted device for being worn by the user, the head mounted device comprising the display.

5. The system of claim 1, further comprising a head mounted device for being worn by the user comprising the input/output interface and the processor.

6. The system of claim 5, wherein the head mounted device further comprises the input/output interface and the processor.

7. The system of claim 5, wherein the head mounted device further comprises the at least one sensor.

8. The system of claim 6, wherein the head mounted device further comprises the at least one sensor.

9. The system of claim 8, further comprising one or more additional sensors positioned in a surrounding area of the user.

10. A system for controlling an event in a virtual reality environment, the system comprising:
a host for providing the virtual reality environment;
an input device having a plurality of control inputs for allowing a user to control the event;
at least one sensor providing for the detection of a real-time body state of the user;
an input/output interface for communicating with the host, the input device and the at least one sensor; and
a processor in communication with the input/output interface, the processor being so configured so as to:
associate the detected real-time body state with at least one of the plurality of control inputs;
provide an input representative of the associated control inputs to the host; and
provide the plurality of control inputs from the input device to the host,
whereby the real-time body state of the user controls the event.

11. A head mounted device for controlling an event in a virtual reality environment provided by a host controlled by an input device having a plurality of control inputs for allowing a user to control the event, the head mounted device comprising:
an input/output interface for communicating with at least one sensor and the host, the at least one sensor providing for the detection of a real-time body state of the user; and
a processor in communication with the input/output interface, the processor being so configured so as to:
associate the detected real-time body state with at least one of the plurality of control inputs; and
provide an input representative of the associated control inputs to the host,
whereby the real-time body state of the user controls the event.

12. The head mounted device of claim 11, further comprising the at least one sensor.

13. The head mounted device of claim 11, further comprising a display for displaying the virtual reality environment to the user.

14. A kit for controlling an event in a virtual reality environment provided by a host controlled by an input device having a plurality of control inputs for allowing a user to control the event, the kit comprising:
at least one sensor providing for the detection of a real-time body state of the user;
an input/output interface for communicating with the at least one sensor and the host; and
a processor in communication with the input/output interface, the processor being so configured so as to:
associate the detected real-time body state with at least one of the plurality of control inputs; and
provide an input representative of the associated control inputs to the host,
whereby the real-time body state of the user controls the event.

15. The kit of claim 14, further comprising a head mounted device, the head mounted device comprises the input/output interface and the processor.

16. The kit of claim 14, wherein the head mounted device further comprises a display for displaying the virtual reality environment.

17. The kit of claim 15, wherein the head mounted device comprises the at least one sensor.

18. The kit of claim 17, further comprising one or more additional sensors positioned in a surrounding area of the user.

19. The kit of claim 14, further comprising the input device.

20. A method for controlling an event in a virtual reality environment provided by a host controlled by an input device having a plurality of control inputs for allowing a user to control the event, the method comprising:
detecting a real-time body state of the user;
associating the detected real-time body state with at least one of the plurality of control inputs; and
providing an input representative of the associated control inputs to the host, whereby the real-time body state of the user controls the event.
